(19) United States
(12) Patent Application Publication
(10) Pub. No.: US 2017/0235823 A1
(43) Pub. Date: Aug. 17, 2017

(54) Clustering method for multilingual documents

(71) Applicant: GUANGDONG ELECTRONICS INDUSTRY INSTITUTE LTD., Dongguan, Guangdong (CN)

(72) Inventors: Zimu Yuan, Dongguan, Guangdong (CN); Peng Peng, Dongguan,Guangdong (CN); Tongkai Ji, Dongguan, Guangdong (CN); Qiang Yue, Dongguan, Guangdong (CN)

(21) Appl. No.: 14/408,461

(22) PCT Filed: Sep. 16, 2013
(86) PCT No.: PCT/CN13/83524

§ 371 Date: May 9, 2017

(51) Int. Cl. G06F 17/30; G06F 17/28; G06F 17/21; G06F 17/27; G06F 17/22

(52) U.S. Cl. CPC G06F 17/30705; G06F 17/30011; G06F 17/2785; G06F 17/2211; G06F 17/274; G06F 17/218; G06F 17/2863

(57) ABSTRACT

The present invention relates to a technical field of information retrieval, and more particularly to a clustering method for multilingual documents, comprising steps of: step 1: establishing a similar words bank comprising multilingual words; step 2: extracting eight eigenvalues; step 3: calculating a similarity of any two documents i and j; step 4: selecting accumulation points from a set of the documents to establish a cluster; step 5: adding residual documents which are not selected in the set to the cluster; and step 6: disposing the cluster in a circular ring structure. The method of the present invention without limiting categories of languages in the documents, the accumulation points are selected according to judgments of similarity to establish clusters and classify multilingual documents in the clusters. The method of the present invention is suitable for clustering multilingual documents.

### CROSS REFERENCE OF RELATED APPLICATION

This is a U.S. National Stage under 35 U.S.C 371 of the International Application PCT/CN2013/083524, filed Sep. 16, 2013, which claims priority under 35 U.S.C. 119(a-d) to CN 201310416693.8, filed Sep. 12, 2013.

### BACKGROUND OF THE PRESENT INVENTION

Field of Invention

The present invention relates to a technical field of information retrieval, and more particularly to a clustering method for multilingual documents.

Description of Related Arts

When accessing to the internet, users often search concerned information on a search engine. Information retrieval systems which are similar to the search engine usually filter and search bulk data, and processing time is required to be fast enough for providing the users a timely response, in such a manner that waiting of the users is avoided.

The clustering technique in the information retrieval system guarantees a searching time fast enough for providing the users sufficient information. Clustering, which refers to categorizing information in the information retrieval system, is an effective improvement strategy in the information retrieval system and capable of providing more complete information for users. Applying clustering technique in information retrieval enables the users to quickly locate contents they interested in during processes of information retrieval. Compared with information retrieval systems without applying the clustering technique, information retrieval systems allying the clustering technique has an effect of reducing waiting time of the users and has characteristics of clearer classification.

### SUMMARY OF THE PRESENT INVENTION

Accordingly, in order to solve technical problems mentioned above, the present invention provides a clustering method for multilingual documents which is capable of fusing the multilingual documents.

Technical solutions for solving the technical problems mentioned above are as follows. A clustering method for multilingual documents, comprising following steps of:

step 1: establishing a similar words bank comprising multilingual words;

step 2: extracting eight eigenvalues;

step 3: calculating a similarity of any two documents i and j according to the eight eigenvalues;

step 4: selecting accumulation points from a set of the documents to establish a cluster;

step 5: adding residual documents which are not selected in the set to the cluster; and

step 6: disposing the cluster in a circular ring structure.

Preferably, wherein in the step 1, multilingual words having identical or similar meanings are recorded in each line of the similar words bank, and whether the multilingual words are verbs or nouns is marked.

Preferably, in the step 2, the eight eigenvalues comprise: an eigenvalue of citation relationships (f₁), an eigenvalue of identical references (f₂), an eigenvalue of identical strings (f₃), an eigenvalue of similar strings (f₄), an eigenvalue of identical nouns (f₅), an eigenvalue of similar nouns (f₆), an eigenvalue of identical verbs (f₇), and an eigenvalue of similar verbs (f₈);

wherein the eight eigenvalues are not limited to a particular language, and the multilingual documents are fused in classification of the clusters;

wherein citation documents refer to references listed in a document;

the identical strings refer to strings formed by a section of identical words;

the similar strings refer to strings having a section of identical words or formed by a section of similar words recorded in the similar words bank;

the identical nouns refer to absolutely identical nouns;

the similar nouns refer to nouns recorded in a same line of the similar words bank;

the identical verbs refer to absolutely identical verbs; and

the similar verbs refer to verbs recorded in a same line of the similar words bank;

wherein for a document i, an eigenvector thereof is F(i),

F(i)=(f₁(i),f₂(i),f₃(i),f₄(i),f₅(i),f₆(i),f₇(i),f₈(i).

Preferably, in the step 3, importance of the eight eigenvalue is f₁>₂>f₃>f₄>f₅>f₆>f₇>f₈;

wherein the step 3 specifically comprises a step of calculating products of eigenvalues of any two documents i and j, wherein the step of calculating the products comprises:

calculating a product of citation documents f₁(i)fᵢ(j), wherein W is defined as a weight of one document in i and j cited by the other document in i and j;

bool represents that whether a citation relationship exists, wherein a value of bool is 0 or 1, the value 0 represents that the citation relationship does not exist, and the value 1 represents that the citation relationship exists; wherein a calculating expression is:

f₁(i)f₁(j)=bool×W;

calculating a product of the identical references f₂(i)f₂(j), wherein d is defined as a weighting factor of division and d≧1;

Refs represents a number of the references;

Max{Refs(i),Refs(j)} represents a maximum of the number of the references selected from i and j;

CommonRefs(i,j) represents a number of identical references in the two documents of i and j, and a calculating expression is:

$${f}_{2} ( i ) {f}_{2} ( j ) = \frac{W}{d} \times \frac{CommonRefs ( i , j )}{Max \{ Refs ( i ) , Refs ( j ) \}} ;$$

calculating a product of the identical strings f₃(i)f₃(j), wherein CommonStrs(i,j) is defined as identical strings in the two documents i and j; Length represents a length of the strings, and thus Length(CommonStrs(i,j)) represents a total length of the identical strings, Max{Length(i),Length(j)} represents a maximum of a total length of the two documents i and j; and a calculating expression is:

$${f}_{3} ( i ) {f}_{3} ( j ) = \frac{W}{{d}^{2}} \times \frac{Length ( CommonStrs ( i , j ) )}{Max \{ Length ( i ) , Length ( j ) \}} ;$$

calculating a product of the similar strings f₄(i)f₄(j), wherein SimilarStrs(i,j) is defined as similar strings in the two documents i and j, and a calculating expression is:

$${f}_{4} ( i ) {f}_{4} ( j ) = \frac{W}{{d}^{3}} \times \frac{Length ( SimilarStrs ( i , j ) )}{Max \{ Length ( i ) , Length ( j ) \}} ;$$

calculating a product of the identical nouns f₅(i)f₅(i), CommonNouns(i,j) is defined as identical nouns in the two documents i and j; Nouns represents a total number of nouns in the documents, and thus Max{Nouns(i), Nouns(j)} represents a maximum of the total number of the nouns in the two documents i and j, and a calculating expression is:

$${f}_{5} ( i ) {f}_{5} ( j ) = \frac{W}{{d}^{4}} \times \frac{CommonNouns ( i , j )}{Max \{ Nouns ( i ) , Nouns ( j ) \}} ;$$

calculating a product of the similar nouns f₆(i)f₆(j), wherein SimilarNouns(i,j) is defined as nouns having similar meanings in the two documents i and j, and a calculating expression is:

$${f}_{6} ( i ) {f}_{6} ( j ) = \frac{W}{{d}^{5}} \times \frac{SimilarNouns ( i , j )}{Max \{ Nouns ( i ) , Nouns ( j ) \}} ;$$

calculating a product of the identical verbs, wherein CommonVerbs(i,j) is defined as identical verbs in the two documents i and j, Verbs represents a total number of verbs in the documents, and thus Max{Verbs(i),Verbs(j)} represents a maximum of the total number of the nouns in the two documents i and j, and a calculating expression is:

$${f}_{7} ( i ) {f}_{7} ( j ) = \frac{W}{{d}^{6}} \times \frac{CommonVerbs ( i , j )}{Max \{ Verbs ( i ) , Verbs ( j ) \}} ;$$

and

calculating a product of the similar verbs f₈(i)f₈(j), SimilarVerbs(i,j) is defined as verbs having similar meanings in the two documents i and j, and a calculating expression is:

$${f}_{8} ( i ) {f}_{8} ( j ) = \frac{W}{{d}^{7}} \times \frac{SimilarVerbs ( i , j )}{Max \{ Verbs ( i ) , Verbs ( j ) \}} ;$$

based on calculations of products of the eigenvalues, a similarity of the two documents i and j is defined as:

$$Proximity ( i , j ) = {\sum }_{q = 1}^{8} {f}_{q} ( i ) {f}_{q} ( j ) .$$

Preferably, in the step 4, on an initial condition, two most dissimilar documents, i.e., with a minimum Proximity(i,j), are selected for serving as two initial accumulation points p₁ and p₂, p₁ and p₂ are added to an accumulation point set denoted as Points; residual accumulation points are selected according to a following maximum and minimum formula:

$${p}_{m + 1} = Arg {Min}_{p ∉ Points} \{ {Max}_{r = 1 , 2 , … , m} Proximity ( p , {p}_{r} ) \} ;$$

wherein in the formula, pᵣ, r=1, 2, . . . , m represents documents selected as the accumulation points, then an (m+1)th accumulation point is selected from documents which haven't been selected as the accumulation points and added to the set Points, a threshold value Th is set for the formula mentioned above; when a stopping accumulation point selected satisfies

$${Min}_{p ∉ Points} \{ Max Proximity ( p , {p}_{r} ) \} > Th ,$$

the accumulation points are stopped selecting; in addition, the stopping accumulation point is not added to the set Points.

Preferably, in the step 5, N represents a total number of documents participating in clustering, M represents a total number of accumulation points selected;

in the beginning, M documents serve as accumulation points of the clustering, residual N−M documents are added in the M clusters;

Cluster(pᵣ), r=1, 2, . . . , M represents a set of each cluster;

in the beginning, each set only has one documents serving as the accumulation points;

for a document i not participating in the clusters, a most similar cluster is calculated according to a following expression:

$${p}_{q} = Arg {Max}_{r = 1 , 2 , … , M} \{ \frac{{Σ}_{p ∈ Cluster ( {p}_{r} )} Proximity ( p , i )}{\vert Cluster ( {p}_{r} ) \vert} \} ;$$

in the expression mentioned above, a similarity of between a document i not added in the clusters and all documents in the set Cluster(pᵣ) of each cluster, an average is taken for serving as a similarity of the document i and the clusters; a maximum of all the clusters is taken for serving as a most similar cluster to the document i;

the residual N−M documents are added to the set of the clusters, each time a document i_{q} having a maximum similarity is added to the set of the clusters, and the Cluster(p_{q}) is updated, and finally all the documents are added to the set of the clusters.

Preferably, in the step 6, M clusters are disposed in the circular ring structure, in such a manner that clusters having more similar characteristics are distributed closer, and clusters having more dissimilar characteristics are distributed farther; wherein in an initial condition, two clusters are randomly selected to be added to the circular ring structure, and residual M−2 clusters are added to the circular ring structure in sequence according to a following formula:

$$( {p}_{s} , {p}_{t} ) = Arg Max \{ \frac{{Σ}_{i ∈ Cluster ( {p}_{r} ) , j ∈ Cluster ( {p}_{s} )} Proximity ( i , j )}{\vert Cluster ( {p}_{r} ) \vert \vert Cluster ( {p}_{s} ) \vert} + \frac{{Σ}_{i ∈ Cluster ( {p}_{r} ) , k ∈ Cluster ( {p}_{t} )} Proximity ( i , k )}{\vert Cluster ( {p}_{r} ) \vert \vert Cluster ( {p}_{t} ) \vert} \} ;$$

when each cluster pᵣ is added to the circular ring structure, a suitable position is sought according to the formula mentioned above and a new ring for disposing the cluster pᵣ is added between two most similar clusters pₛ and pₜ;

wherein in the circular ring structure, the closer is a cluster to the cluster pᵣ, the more similar is the cluster to the cluster pᵣ; and otherwise the farther is a cluster to the cluster pᵣ, the more dissimilar is the cluster to the cluster pᵣ.

The clustering method of the present invention is capable of fusing multilingual documents, and linking multilingual words by the similar words bank. Based on the similar words bank and other information, the eigenvalues are extracted and the accumulation points are selected for classifying. According to the similarity, the documents are added to the clusters, and according to the similarity the clusters are added to the circular ring structure for arrangement. The present invention is capable of helping users to quickly look up a series of documents in relative classification by key words. Compared with a condition that the clustering mechanism is not provided, the present invention is capable of responding in a faster speed, avoiding troubles of manually looking up of the users and reducing waiting time of the users. The method of the present invention is capable of providing clear classification for the documents, providing more accurate and complete information, in such a manner that the users are capable of fully understanding progress of subjects that the documents belongs to in the classification.

### BRIEF DESCRIPTION OF THE DRAWINGS

Further description of the present invention is illustrated combining with accompanying drawings.

FIG. 1 is a schematic view of a clustering mechanism with fusion of multilingual documents according to a preferred embodiment of the present invention.

FIG. 2 is a schematic view of accumulation points selected according to the preferred embodiment of the present invention.

FIG. 3 is an implementing view according to the preferred embodiment of the present invention showing that clusters are disposed in a circular ring structure.

FIG. 4 is a schematic view according to the preferred embodiment of the present invention showing that clusters are disposed in a circular ring structure.

FIG. 5 is a schematic view showing that the clusters are disposed in the circular ring structure according to the preferred embodiment of the present invention.

### DETAILED DESCRIPTION OF THE PREFERRED EMBODIMENT

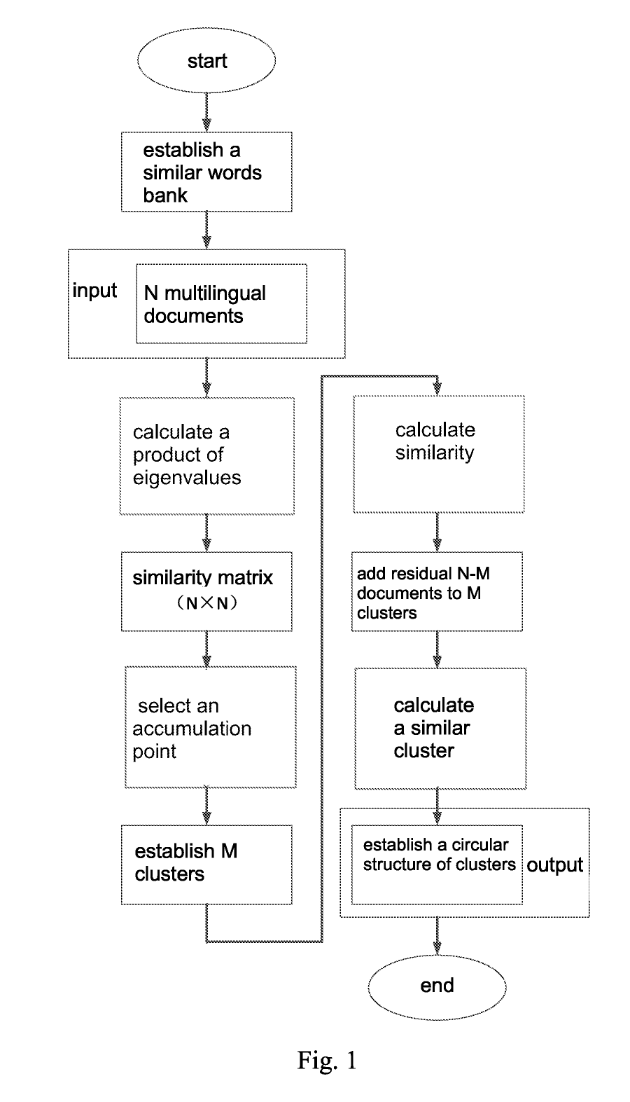

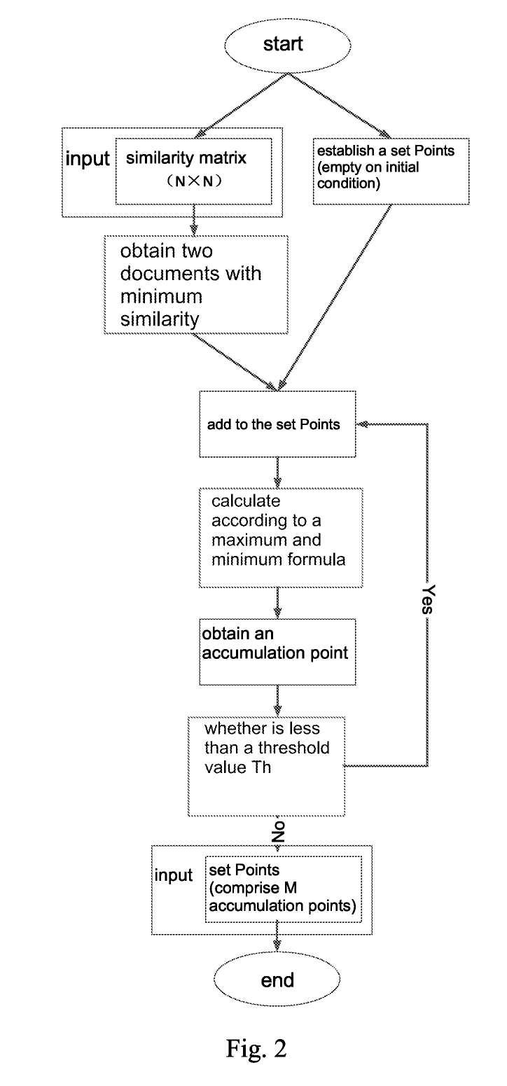

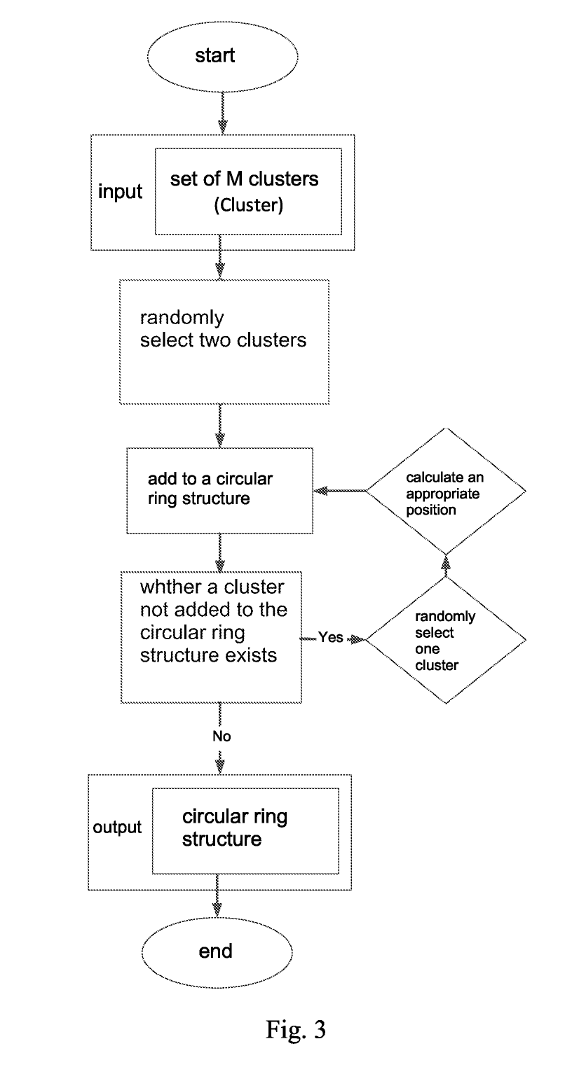

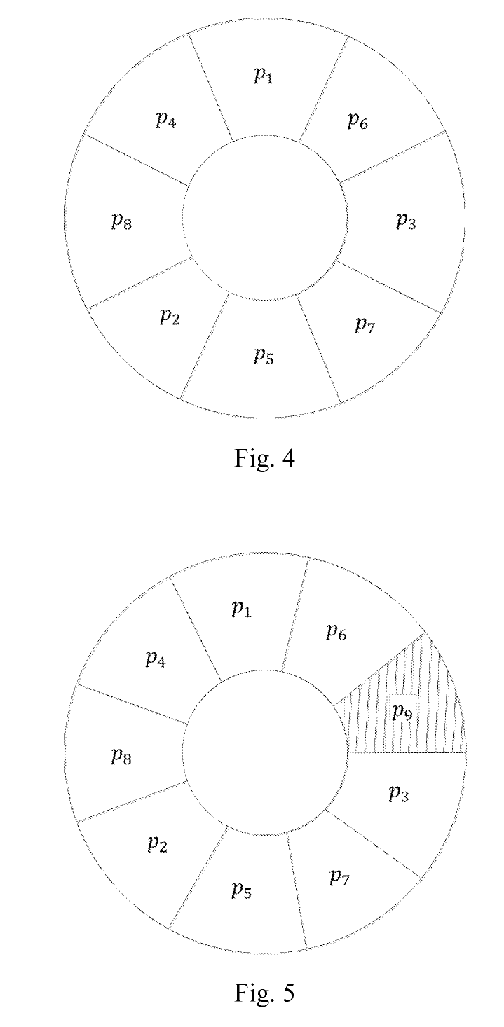

Referring to FIGS. 1-5, a process of the method of the present invention is as follows.

Firstly, a similar words bank is established, wherein multilingual words having identical or similar meanings are recorded in each line of the similar words bank, and whether the words are verbs or nouns is marked. N documents participating in clustering serves as an input.

Based on the similar words bank, contents and citations of the documents, extract eight eigenvalues of citation relationship (f₁), identical references (f₂), identical strings (f₃), similar strings (f₄), identical nouns (f₅), similar nouns (f₆), identical verbs (f₇) and similar verbs (f₈) to form an eigenvector F(i),

F(i)=(f₁(i),f₂(i),f₃(i),f₄(i),f₅(i),f₆(i),f₇(i),f₈(i)).

Calculate a product of references

f₁(i)f₁(j)=bool×W;

calculate a product of the identical references

$${f}_{2} ( i ) {f}_{2} ( j ) = \frac{W}{d} \times \frac{CommonRefs ( i , j )}{Max \{ Refs ( i ) , Refs ( j ) \}} ;$$

calculate a product of the identical strings

$${f}_{3} ( i ) {f}_{3} ( j ) = \frac{W}{{d}^{2}} \times \frac{Length ( CommonStrs ( i , j ) )}{Max \{ Length ( i ) , Length ( j ) \}} ;$$

calculate a product of the similar strings

$${f}_{4} ( i ) {f}_{4} ( j ) = \frac{W}{{d}^{3}} \times \frac{Length ( SimilarStrs ( i , j ) )}{Max \{ Length ( i ) , Length ( j ) \}} ;$$

calculate a product of the identical nouns

$${f}_{5} ( i ) {f}_{5} ( j ) = \frac{W}{{d}^{4}} \times \frac{CommonNouns ( i , j )}{Max \{ Nouns ( i ) , Nouns ( j ) \}} ;$$

calculate a product of the similar nouns

$${f}_{6} ( i ) {f}_{6} ( j ) = \frac{W}{{d}^{5}} \times \frac{SimilarNouns ( i , j )}{Max \{ Nouns ( i ) , Nouns ( j ) \}} ;$$

calculate a product of the identical verbs

$${f}_{7} ( i ) {f}_{7} ( j ) = \frac{W}{{d}^{6}} \times \frac{CommonVerbs ( i , j )}{Max \{ Verbs ( i ) , Verbs ( j ) \}} ;$$

calculate a product of the similar verbs

$${f}_{8} ( i ) {f}_{8} ( j ) = \frac{W}{{d}^{7}} \times \frac{SimilarVerbs ( i , j )}{Max \{ Verbs ( i ) , Verbs ( j ) \}} .$$

Based on calculation of product of the eigenvalues, similarity of any two documents i and j is calculated, Proximity(i,j)==Σ_{q=1}⁸f_{q}(i)f_{q}(j). Thus, the N documents in total form an N×N similarity matrix.

Based on the N×N similarity matrix, accumulation points are selected from a set of the documents. On an initial condition, two most dissimilar documents, i.e., with a minimum Proximity(i,j), are selected for serving as two initial accumulation points p₁ and p₂. Add p₁ and p₂ to an accumulation point set denoted as Points. Residual accumulation points are selected according to a following maximum and minimum

$${p}_{m + 1} = Arg {Min}_{p ∉ Points} \{ {Max}_{r = 1 , 2 , … , m} Proximity ( p , {p}_{r} ) \} .$$

Add the residual accumulation points to the accumulation point set Points in sequence. Until a stopping accumulation point greater than a threshold value Th is selected, i.e.,

$${Min}_{p ∉ Points} \{ Max Proximity ( p , {p}_{r} ) \} > Th ,$$

stop selecting accumulation points, wherein the stopping accumulation point is not added to the set Points.

In the formula, pᵣ, r=1, 2, . . . , m represents documents selected as the accumulation points. Then an (m+1)th accumulation point is selected from documents which haven't been selected as the accumulation points and added to the set Points. A threshold value Th is set for the formula mentioned above. When a stopping accumulation point selected satisfies

$${Min}_{p ∉ Points} \{ Max Proximity ( p , {p}_{r} ) \} > Th ,$$

stop selecting the accumulation points. In addition, the stopping accumulation point is not added to the set Points. Thus, M accumulation points, i.e., M clusters, are selected.

Add residual N−M documents to the M clusters denoted as Cluster(pᵣ), r=1, 2, . . . , M. In the beginning, each set only has one documents selected as the accumulation points. For a document i not added to the clusters, calculate a most similar cluster according to a formula

$${p}_{q} = Arg {Max}_{r = 1 , 2 , … , M} \{ \frac{{\sum }_{p ∈ Cluster ( {p}_{r} )} Proximity ( p , i )}{\vert Cluster ( {p}_{r} ) \vert} \} .$$

The residual N−M documents are added in sequence to a set of the cluster. Select a document i_{q} with a greatest similarity is in each time to add to the set of the cluster and update the Cluster(p_{q}) till all documents are added to the set of the cluster.

Dispose the M clusters in a structure of a circular ring. At the beginning, two of the clusters are randomly selected and disposed in the circular ring. M−2 clusters are left. Randomly select one cluster is randomly from the M−2 clusters, and find an appropriate position for the cluster selected in the circular ring according to a formula

$$( {p}_{s} , {p}_{t} ) = Arg Max \{ \frac{{\sum }_{i ∈ Cluster ( {p}_{r} ) , j ∈ Cluster ( {p}_{s} )} Proximity ( i , j )}{\vert Cluster ( {p}_{r} ) \vert \vert Cluster ( {p}_{s} ) \vert} + \frac{{\sum }_{i ∈ Cluster ( {p}_{r} ) , k ∈ Cluster ( {p}_{t} )} Proximity ( i , k )}{\vert Cluster ( {p}_{r} ) \vert \vert Cluster ( {p}_{t} ) \vert} \} .$$

A new ring pᵣ is added between the clusters pₛ and pₜ which are most similar.

In the whole process, a final output comprises the M clusters and is disposed in the structure of the circular ring. Each cluster comprises similar documents without restriction on languages. The closer is a distance between clusters in the structure of the circular ring, the more similar are the clusters; and otherwise the farther is the distance therebetween, the more dissimilar are the clusters.

1-11. (canceled)

12: A clustering method for multilingual documents, comprising following steps of:
step 1: establishing a similar words bank comprising multilingual words;
step 2: extracting eight eigenvalues;
step 3: calculating a similarity of any two documents i and j according to the eight eigenvalues;
step 4: selecting accumulation points from a set of the documents to establish a cluster;
step 5: adding residual documents which are not selected in the set to the cluster; and
step 6: disposing the cluster in a circular ring structure.

13: The clustering method, as recited in claim 12, wherein in the step 1, multilingual words having identical or similar meanings are recorded in each line of the similar words bank, and whether the multilingual words are verbs or nouns is marked.

14: The clustering method, as recited in claim 12, wherein in the step 2, the eight eigenvalues comprise: an eigenvalue of citation relationships (f₁), an eigenvalue of identical references (f₂), an eigenvalue of identical strings (f₃), an eigenvalue of similar strings (f₄), an eigenvalue of identical nouns (f₅), an eigenvalue of similar nouns (f₆), an eigenvalue of identical verbs (f₇), and an eigenvalue of similar verbs (f₈);
wherein the eight eigenvalues are not limited to a particular language, and the multilingual documents are fused in classification of the clusters;
wherein citation documents refer to references listed in a document;
the identical strings refer to strings formed by a section of identical words;
the similar strings refer to strings having a section of identical words or formed by a section of similar words recorded in the similar words bank;
the identical nouns refer to absolutely identical nouns;
the similar nouns refer to nouns recorded in a same line of the similar words bank;
the identical verbs refer to absolutely identical verbs; and
the similar verbs refer to verbs recorded in a same line of the similar words bank;
wherein for a document i, an eigenvector thereof is F(i),
F(i)=(f₁(i),f₂(i),f₃(i),f₄(i),f₅(i),f₆(i),f₇(i),f₈(i)).

15: The clustering method, as recited in claim 13, wherein in the step 2, the eight eigenvalues comprise: an eigenvalue of citation relationships (f₁), an eigenvalue of identical references (f₂), an eigenvalue of identical strings (f₃), an eigenvalue of similar strings (f₄), an eigenvalue of identical nouns (f₅), an eigenvalue of similar nouns (f₆), an eigenvalue of identical verbs (f₇) and an eigenvalue of similar verbs (f₈);
wherein the eight eigenvalues are not limited to a particular language, and the multilingual documents are fused in classification of the clusters;
wherein citation documents refer to references listed in a document;
the identical strings refer to strings formed by a section of identical words;
the similar strings refer to strings having a section of identical words or formed by a section of similar words recorded in the similar words bank;
the identical nouns refer to absolutely identical nouns;
the similar nouns refer to nouns recorded in a same line of the similar words bank;
the identical verbs refer to absolutely identical verbs; and
the similar verbs refer to verbs recorded in a same line of the similar words bank;
wherein for a document i, an eigenvector thereof is F(i),
F(i)=(f₁(i),f₂(i),f₃(i),f₄(i),f₅(i),f₆(i),f₇(i),f₈(i)).

16: The clustering method, as recited in claim 12, wherein in the step 3, importance of the eight eigenvalues is f₁>f₂>f₃>f₄>f₅>f₆>f₇>f₈;
wherein the step 3 specifically comprises a step of calculating products of eigenvalues of any two documents i and j, wherein the step of calculating the products comprises:
calculating a product of citation documents f₁(i)f₁(j), wherein W is defined as a weight of one document in i and j cited by the other document in i and j;
bool represents that whether a citation relationship exists, wherein a value of bool is 0 or 1, the value 0 represents that the citation relationship does not exist, and the value 1 represents that the citation relationship exists; wherein a calculating expression is:
f₁(i)f₁(j)=bool×W;
calculating a product of the identical references f₂(i)f₂(j), wherein d is defined as a weighting factor of division and d≧1;
Refs represents a number of the references;
Max{Refs(i),Refs(j)} represents a maximum of the number of the references selected from i and j;
CommonRefs(i,j) represents a number of identical references in the two documents of i and j, and a calculating expression is:
$${f}_{2} ( i ) {f}_{2} ( j ) = \frac{W}{d} \times \frac{CommonRefs ( i , j )}{Max \{ Refs ( i ) , Refs ( j ) \}} ;$$
calculating a product of the identical strings f₃(i)f₃(j), wherein CommonStrs(i,j) is defined as identical strings in the two documents i and j; Length represents a length of the strings, and thus Length(CommonStrs(i,j)) represents a total length of the identical strings, Max{Length(i),Length(j)} represents a maximum of a total length of the two documents i and j; and a calculating expression is:
$${f}_{3} ( i ) {f}_{3} ( j ) = \frac{W}{{d}^{2}} \times \frac{Length ( CommonStrs ( i , j ) )}{Max \{ Length ( i ) , Length ( j ) \}} ;$$
calculating a product of the similar strings f₄(i)f₄(j), wherein SimilarStrs(i,j) is defined as similar strings in the two documents i and j, and a calculating expression is:
$${f}_{4} ( i ) {f}_{4} ( j ) = \frac{W}{{d}^{3}} \times \frac{Length ( SimilarStrs ( i , j ) )}{Max \{ Length ( i ) , Length ( j ) \}} ;$$
and
calculating a product of the identical nouns f₅(i)f₅(j), CommonNouns(i,j) is defined as identical nouns in the two documents i and j; Nouns represents a total number of nouns in the documents, and thus Max{Nouns(i),Nouns(j)} represents a maximum of the total number of the nouns in the two documents i and j, and a calculating expression is:
$${f}_{5} ( i ) {f}_{5} ( j ) = \frac{W}{{d}^{4}} \times \frac{CommonNouns ( i , j )}{Max \{ Nouns ( i ) , Nouns ( j ) \}} ;$$
calculating a product of the similar nouns f₆(i)f₆(j), wherein SimilarNouns(i,j) is defined as nouns having similar meanings in the two documents i and j, and a calculating expression is:
$${f}_{6} ( i ) {f}_{6} ( j ) = \frac{W}{{d}^{5}} \times \frac{SimilarNouns ( i , j )}{Max \{ Nouns ( i ) , Nouns ( j ) \}} ;$$
calculating a product of the identical verbs, wherein CommonVerbs(i,j) is defined as identical verbs in the two documents i and j, Verbs represents a total number of verbs in the documents, and thus Max{Verbs(i), Verbs(j)} represents a maximum of the total number of the nouns in the two documents i and j, and a calculating expression is:
$${f}_{7} ( i ) {f}_{7} ( j ) = \frac{W}{{d}^{6}} \times \frac{CommonVerbs ( i , j )}{Max \{ Verbs ( i ) , Verbs ( j ) \}} ;$$
and
calculating a product of the similar verbs f₈(i)f₈(j), SimilarVerbs(i,j) is defined as verbs having similar meanings in the two documents i and j, and a calculating expression is:
$${f}_{8} ( i ) {f}_{8} ( j ) = \frac{W}{{d}^{7}} \times \frac{SimilarVerbs ( i , j )}{Max \{ Verbs ( i ) , Verbs ( j ) \}} ;$$
based on calculations of products of the eigenvalues, a similarity of the two documents i and j is defined as:
$$Proximity ( i , j ) = {\sum }_{q = 1}^{8} {f}_{q} ( i ) {f}_{q} ( j ) .$$

17: The clustering method, as recited in claim 13, wherein in the step 3, importance of the eight eigenvalue is f₁>f₂>f₃>f₄>f₅>f₆>f₇>f₈;
wherein the step 3 specifically comprises a step of calculating products of eigenvalues of any two documents i and j, wherein the step of calculating the products comprises:
calculating a product of citation documents f₁(i)f₁(j), wherein W is defined as a weight of one document in i and j cited by the other document in i and j;
bool represents that whether a citation relationship exists, wherein a value of bool is 0 or 1, the value 0 represents that the citation relationship does not exist, and the value 1 represents that the citation relationship exists; wherein a calculating expression is:
f₁(i)f₁(j)=bool×W;
calculating a product of the identical references f₂(i)f₂ (j), wherein d is defined as a weighting factor of division and d≧1;
Refs represents a number of the references;
Max{Refs(i),Refs(j)} represents a maximum of the number of the references selected from i and j;
CommonRefs(i,j) represents a number of identical references in the two documents of i and j, and a calculating expression is:
$${f}_{2} ( i ) {f}_{2} ( j ) = \frac{W}{d} \times \frac{CommonRefs ( i , j )}{Max \{ Refs ( i ) , Refs ( j ) \}} ;$$
calculating a product of the identical strings f₃(i)f₃(j), wherein CommonStrs(i,j) is defined as identical strings in the two documents i and j; Length represents a length of the strings, and thus Length(CommonStrs(i,j)) represents a total length of the identical strings, Max{Length(i),Length(j)} represents a maximum of a total length of the two documents i and j; and a calculating expression is:
$${f}_{3} ( i ) {f}_{3} ( j ) = \frac{W}{{d}^{2}} \times \frac{Legnth ( CommonStrs ( i , j ) )}{Max \{ Legnth ( i ) , Legnth ( j ) \}} ;$$
calculating a product of the similar strings f₄(i)f₄(j), wherein SimilarStrs(i,j) is defined as similar strings in the two documents i and j, and a calculating expression is:
$${f}_{4} ( i ) {f}_{4} ( j ) = \frac{W}{{d}^{3}} \times \frac{Length ( SimilarStrs ( i , j ) )}{Max \{ Length ( i ) , Length ( j ) \}} ;$$
calculating a product of the identical nouns f₅(i)f₅(j), CommonNouns(i,j) is defined as identical nouns in the two documents i and j; Nouns represents a total number of nouns in the documents, and thus Max{Nouns(i),Nouns(j)} represents a maximum of the total number of the nouns in the two documents i and j, and a calculating expression is:
$${f}_{5} ( i ) {f}_{5} ( j ) = \frac{W}{{d}^{4}} \times \frac{CommonNouns ( i , j )}{Max \{ Nouns ( i ) , Nouns ( j ) \}} ;$$
calculating a product of the similar nouns f₆(i)f₆(j), wherein SimilarNouns(i,j) is defined as nouns having similar meanings in the two documents i and j, and a calculating expression is:
$${f}_{6} ( i ) {f}_{6} ( j ) = \frac{W}{{d}^{5}} \times \frac{SimilarNouns ( i , j )}{Max \{ Nouns ( i ) , Nouns ( j ) \}} ;$$
calculating a product of the identical verbs, wherein CommonVerbs(i,j) is defined as identical verbs in the two documents i and j, Verbs represents a total number of verbs in the documents, and thus Max{Verbs(i), Verbs(j)} represents a maximum of the total number of the nouns in the two documents i and j, and a calculating expression is:
$${f}_{7} ( i ) {f}_{7} ( j ) = \frac{W}{{d}^{6}} \times \frac{CommonVerbs ( i , j )}{Max \{ Verbs ( i ) , Verbs ( j ) \}} ;$$
and
calculating a product of the similar verbs f₈(i)f₈(j), SimilarVerbs(i,j) is defined as verbs having similar meanings in the two documents i and j, and a calculating expression is:
$${f}_{8} ( i ) {f}_{8} ( j ) = \frac{W}{{d}^{7}} \times \frac{SimilarVerbs ( i , j )}{Max \{ Verbs ( i ) , Verbs ( j ) \}} ;$$
based on calculations of products of the eigenvalues, a similarity of the two documents i and j is defined as:
$$Proximity ( i , j ) = {\sum }_{q = 1}^{8} {f}_{q } ( i ) {f}_{q} ( j ) .$$

18: The clustering method, as recited in claim 14, wherein, in the step 3, importance of the eight eigenvalue is f₁>f₂>f₃>f₄>f₅>f₆>f₇>f₈;
wherein the step 3 specifically comprises a step of calculating products of eigenvalues of any two documents i and j, wherein the step of calculating the products comprises:
calculating a product of citation documents f₁(i)f₁(j), wherein W is defined as a weight of one document in i and j cited by the other document in i and j;
bool represents that whether a citation relationship exists, wherein a value of bool is 0 or 1, the value is 0 represents that the citation relationship does not exist, and the value 1 represents that the citation relationship exists; wherein a calculating expression is:
f₁(i)f₁(j)=bool×W;
calculating a product of the identical references f₂(i)f₂(j), wherein d is defined as a weighting factor of division and d≧1;
Refs represents a number of the references;
Max{Refs(i),Refs(j)} represents a maximum of the number of the references selected from i and j;
CommonRefs(i,j) represents a number of identical references in the two documents of i and j, and a calculating expression is:
$${f}_{2} ( i ) {f}_{2} ( j ) = \frac{W}{d} \times \frac{CommonRefs ( i , j )}{Max \{ Refs ( i ) , Refs ( j ) \}} ;$$
calculating a product of the identical strings f₃(i)f₃(j), wherein CommonStrs(i,j) is defined as identical strings in the two documents i and j; Length represents a length of the strings, and thus Length(CommonStrs(i,j)) represents a total length of the identical strings, Max{Length(i),Length(j)} represents a maximum of a total length of the two documents i and j; and a calculating expression is:
$${f}_{3} ( i ) {f}_{3} ( j ) = \frac{W}{{d}^{2}} \times \frac{Length ( CommonStrs ( i , j ) )}{Max \{ Length ( i ) , Length ( j ) \}} ;$$
calculating a product of the similar strings f₄(i)f₄(j), wherein SimilarStrs(i,j) is defined as similar strings in the two documents i and j, and a calculating expression is:
$${f}_{4} ( i ) {f}_{4} ( j ) = \frac{W}{{d}^{3}} \times \frac{Length ( SimilarStrs ( i , j ) )}{Max \{ Length ( i ) , Length ( j ) \}} ;$$
calculating a product of the identical nouns f₅(i)f₅(j), CommonNouns(i,j) is defined as identical nouns in the two documents i and j; Nouns represents a total number of nouns in the documents, and thus Max{Nouns(i),Nouns(j)} represents a maximum of the total number of the nouns in the two documents i and j, and a calculating expression is:
$${f}_{5} ( i ) {f}_{5} ( i ) = \frac{W}{{d}^{4}} \times \frac{CommonNouns ( i , j )}{Max \{ Nouns ( i ) , Nouns ( j ) \}} ;$$
calculating a product of the similar nouns f₆(i)f₆(j), wherein SimilarNouns(i,j) is defined as nouns having similar meanings in the two documents i and j, and a calculating expression is:
$${f}_{6} ( i ) {f}_{6} ( i ) = \frac{W}{{d}^{5}} \times \frac{SimilarNouns ( i , j )}{Max \{ Nouns ( i ) , Nouns ( j ) \}} ;$$
calculating a product of the identical verbs, wherein CommonVerbs(i,j) is defined as identical verbs in the two documents i and j, Verbs represents a total number of verbs in the documents, and thus Max{Verbs(i), Verbs(j)} represents a maximum of the total number of the nouns in the two documents i and j, and a calculating expression is:
$${f}_{7} ( i ) {f}_{7} ( i ) = \frac{W}{{d}^{6}} \times \frac{CommonVerbs ( i , j )}{Max \{ Verbs ( i ) , Verbs ( j ) \}} ;$$
and calculating a product of the similar verbs f_{g}(i)f_{g}(j), SimilarVerbs(i,j) is defined as verbs having similar meanings in the two documents iand j, and a calculating expression is:
$${f}_{8} ( i ) {f}_{8} ( i ) = \frac{W}{{d}^{7}} \times \frac{SimilarVerbs ( i , j )}{Max \{ Verbs ( i ) , Verbs ( j ) \}} ;$$
based on calculations of products of the eigenvalues, a similarity of the two documents i and j is defined as:
$$Proximity ( i , j ) = {\sum }_{q = 1}^{8} {f}_{q} ( i ) {f}_{q} ( i ) .$$

19: The clustering method, as recited in claim 15, wherein, in the step 3, importance of the eight eigenvalues is f₁>f₂>f₃>f₄>f₅>f₆>f₇>f₈;
wherein the step 3 specifically comprises a step of calculating products of eigenvalues of any two documents i and j, wherein the step of calculating the products comprises:
calculating a product of citation documents f₁(i)f₁(j), wherein W is defined as a weight of one document in i and j cited by the other document in i and j;
bool represents that whether a citation relationship exists, wherein a value of bool is 0 or 1, the value is 0 represents that the citation relationship does not exist, and the value 1 represents that the citation relationship exists; wherein a calculating expression is:
f₁(i)f₁(j)=bool×W;
calculating a product of the identical references f₂(i)f₂(j), wherein d is defined as a weighting factor of division and d≧1;
Refs represents a number of the references;
Max{Refs(i),Refs(j)} represents a maximum of the number of the references selected from i and j;
CommonRefs(i,j) represents a number of identical references in the two documents of i and j, and a calculating expression is:
$${f}_{2} ( i ) {f}_{2} ( i ) = \frac{W}{d} \times \frac{CommonRefs ( i , j )}{Max \{ Refs ( i ) , Refs ( j ) \}} ;$$
calculating a product of the identical strings f₃(i)f₃(j), wherein CommonStrs(i,j) is defined as identical strings in the two documents i and j; Length represents a length of the strings, and thus Length(CommonStrs(i,j)) represents a total length of the identical strings, Max{Length(i),Length(j)} represents a maximum of a total length of the two documents i and j; and a calculating expression is:
$${f}_{3} ( i ) {f}_{3} ( i ) = \frac{W}{{d}^{2}} \times \frac{Length ( CommonStrs ( i , j ) )}{Max \{ Length ( i ) , Length ( j ) \}} ;$$
calculating a product of the similar strings f₄(i)f₄(j), wherein SimilarStrs(i,j) is defined as similar strings in the two documents i and j, and a calculating expression is:
$${f}_{4} ( i ) {f}_{4} ( i ) = \frac{W}{{d}^{3}} \times \frac{Length ( SimilarStrs ( i , j ) )}{Max \{ Length ( i ) , Length ( j ) \}} ;$$
calculating a product of the identical nouns f₅(i)f₅(j), CommonNouns(i,j) is defined as identical nouns in the two documents i and j; Nouns represents a total number of nouns in the documents, and thus Max{Nouns(i),Nouns(j)} represents a maximum of the total number of the nouns in the two documents i and j, and a calculating expression is:
$${f}_{5} ( i ) {f}_{5} ( i ) = \frac{W}{{d}^{4}} \times \frac{CommonNouns ( i , j )}{Max \{ Nouns ( i ) , Nouns ( j ) \}} ;$$
calculating a product of the similar nouns f₆(i)f₆(j), wherein SimilarNouns(i,j) is defined as nouns having similar meanings in the two documents i and j, and a calculating expression is:
$${f}_{6} ( i ) {f}_{6} ( i ) = \frac{W}{{d}^{5}} \times \frac{SimilarNouns ( i , j )}{Max \{ Nouns ( i ) , Nouns ( j ) \}} ;$$
calculating a product of the identical verbs, wherein CommonVerbs(i,j) is defined as identical verbs in the two documents i and j, Verbs represents a total number of verbs in the documents, and thus Max{Verbs(i), Verbs(j)} represents a maximum of the total number of the nouns in the two documents i and j, and a calculating expression is:
$${f}_{7} ( i ) {f}_{7} ( i ) = \frac{W}{{d}^{6}} \times \frac{CommonVerbs ( i , j )}{Max \{ Verbs ( i ) , Verbs ( j ) \}} ;$$
and
calculating a product of the similar verbs f₈(i)f₈(j), SimilarVerbs(i,j) is defined as verbs having similar meanings in the two documents i and j, and a calculating expression is:
$${f}_{8} ( i ) {f}_{8} ( i ) = \frac{W}{{d}^{7}} \times \frac{SimilarVerbs ( i , j )}{Max \{ Verbs ( i ) , Verbs ( j ) \}} ;$$
based on calculations of products of the eigenvalues, a similarity of the two documents i and j is defined as:
$$Proximity ( i , j ) = {\sum }_{q = 1}^{8} {f}_{q} ( i ) {f}_{q} ( i ) .$$

20: The clustering method, as recited in claim 12, wherein in the step 4, on an initial condition, two most dissimilar documents, i.e., with a minimum Proximity(i,j), are selected for serving as two initial accumulation points p₁ and p₂, p₁ and p₂ are added to an accumulation point set denoted as Points; residual accumulation points are selected according to a following maximum and minimum formula:
$${p}_{m + 1} = Arg {Min}_{p ∉ Points} \{ {Max}_{r = 1 , 2 , … , m} Proximity ( p , {p}_{r} ) \} ;$$
wherein in the formula, pᵣ, r=1, 2, . . . , m represents documents selected as the accumulation points, then an (m+1)th accumulation point is selected from documents which haven't been selected as the accumulation points and added to the set Points, a threshold value Th is set for the formula mentioned above; when a stopping accumulation point selected satisfies
$${Min}_{p ∉ Points} \{ Max Proximity ( p , {p}_{r} ) \} > Th ,$$
the accumulation points are stopped selecting; in addition, the stopping accumulation point is not added to the set Points.

21: The clustering method, as recited in claim 13, wherein in the step 4, on an initial condition, two most dissimilar documents, i.e., with a minimum Proximity(i,j), are selected for serving as two initial accumulation points p₁ and p₂, p₁ and p₂ are added to an accumulation point set denoted as Points; residual accumulation points are selected according to a following maximum and minimum formula:
$${p}_{m + 1} = Arg {Min}_{p ∉ Points} \{ {Max}_{r = 1 , 2 , … , m} Proximity ( p , {p}_{r} ) \} ;$$
wherein in the formula, pᵣ, r=1, 2, . . . , m represents documents selected as the accumulation points, then an (m+1)th accumulation point is selected from documents which haven't been selected as the accumulation points and added to the set Points, a threshold value Th is set for the formula mentioned above; when a stopping accumulation point selected satisfies
$${Min}_{p ∉ Points} \{ Max Proximity ( p , {p}_{r} ) \} > Th ,$$
the accumulation points are stopped selecting; in addition, the stopping accumulation point is not added to the set Points.

22: The clustering method, as recited in claim 14, wherein in the step 4, on an initial condition, two most dissimilar documents, i.e., with a minimum Proximity(i,j), are selected for serving as two initial accumulation points p₁ and p₂, p₁ and p₂ are added to an accumulation point set denoted as Points; residual accumulation points are selected according to a following maximum and minimum formula:
$${p}_{m + 1} = Arg {Min}_{p ∉ Points} \{ {Max}_{r = 1 , 2 , … , m} Proximity ( p , {p}_{r} ) \} ;$$
wherein in the formula, pᵣ, r=1, 2, . . . , m represents documents selected as the accumulation points, then an (m+1)th accumulation point is selected from documents which haven't been selected as the accumulation points and added to the set Points, a threshold value Th is set for the formula mentioned above; when a stopping accumulation point selected satisfies
$${Min}_{p ∉ Points} \{ Max Proximity ( p , {p}_{r} ) \} > Th ,$$
the accumulation points are stopped selecting; in addition, the stopping accumulation point is not added to the set Points.

23: The clustering method, as recited in claim 15, wherein in the step 4, on an initial condition, two most dissimilar documents, i.e., with a minimum Proximity(i,j), are selected for serving as two initial accumulation points p₁ and p₂, p₁ and p₂ are added to an accumulation point set denoted as Points; residual accumulation points are selected according to a following maximum and minimum formula:
$${p}_{m + 1} = Arg {Min}_{p ∉ Points} \{ {Max}_{r = 1 , 2 , … , m} Proximity ( p , {p}_{r} ) \} ;$$
wherein in the formula, pᵣ, r=1, 2, . . . , m represents documents selected as the accumulation points, then an (m+1)th accumulation point is selected from documents which haven't been selected as the accumulation points and added to the set Points, a threshold value Th is set for the formula mentioned above; when a stopping accumulation point selected satisfies
$${Min}_{p ∉ Points} \{ Max Proximity ( p , {p}_{r} ) \} > Th ,$$
the accumulation points are stopped selecting; in addition, the stopping accumulation point is not added to the set Points.

24: The clustering method, as recited in claim 16, wherein in the step 4, on an initial condition, two most dissimilar documents, i.e., with a minimum Proximity(i,j), are selected for serving as two initial accumulation points p₁ and p₂, p₁ and p₂ are added to an accumulation point set denoted as Points; residual accumulation points are selected according to following maximum and minimum formula:
$${p}_{m + 1} = Arg {Min}_{p ∉ Points} \{ {Max}_{r = 1 , 2 , … , m} Proximity ( p , {p}_{r} ) \} ;$$
wherein in the formula, pᵣ, r=1, 2, . . . , m represents documents selected as the accumulation points, then an (m+1)th accumulation point is selected from documents which haven't been selected as the accumulation points and added to the set Points, a threshold value Th is set for the formula mentioned above; when a stopping accumulation point selected satisfies
$${Min}_{p ∉ Points} \{ Max Proximity ( p , {p}_{r} ) \} > Th ,$$
the accumulation points are stopped selecting; in addition, the stopping accumulation point is not added to the set Points.

25: The clustering method, as recited in claim 12, wherein in the step 5, N represents a total number of documents participating in clustering, M represents a total number of accumulation points selected;
in the beginning, M documents serve as accumulation points of the clustering, residual N−M documents are added in the M clusters;
Cluster(pᵣ), r=1, 2, . . . , M represents a set of each cluster;
in the beginning, each set only has one documents serving as the accumulation points;
for a document i not participating in the clusters, a most similar cluster is calculated according to a following expression:
$${p}_{q} = Arg {Max}_{r = 1 , 2 , … , M} \{ \frac{{\sum }_{p ∈ Cluster ( {p}_{r} )} Proximity ( p , i )}{\vert Cluster ( {p}_{r} ) \vert} \} ;$$
in the expression mentioned above, a similarity of between a document i not added in the clusters and all documents in the set Cluster(pᵣ) of each cluster, an average is taken for serving as a similarity of the document i and the clusters;
a maximum of all the clusters is taken for serving as a most similar cluster to the document i;
the residual N−M documents are added to the set of the clusters, each time a document i_{q} having a maximum similarity is added to the set of the clusters, and the Cluster(p_{q}) is updated, and finally all the documents are added to the set of the clusters.

26: The clustering method, as recited in claim 13, wherein in the step 5, N represents a total number of documents participating in clustering, M represents a total number of accumulation points selected;
in the beginning, M documents serve as accumulation points of the clustering, residual N−M documents are added in the M clusters;
Cluster(pᵣ), r=1, 2, . . . , M represents a set of each cluster;
in the beginning, each set only has one documents serving as the accumulation points;
for a document i not participating in the clusters, a most similar cluster is calculated according to a following expression:
$${p}_{q} = Arg {Max}_{r = 1 , 2 , … , M} \{ \frac{{\sum }_{p ∈ Cluster ( {p}_{r} )} Proximity ( p , i )}{\vert Cluster ( {p}_{r} ) \vert} \} ;$$
in the expression mentioned above, a similarity of between a document i not added in the clusters and all documents in the set Cluster(pᵣ) of each cluster, an average is taken for serving as a similarity of the document i and the clusters;
a maximum of all the clusters is taken for serving as a most similar cluster to the document i;
the residual N−M documents are added to the set of the clusters, each time a document i_{q} having a maximum similarity is added to the set of the clusters, and the Cluster(p_{q}) is updated, and finally all the documents are added to the set of the clusters.

27: The clustering method, as recited in claim 14, wherein in the step 5, N represents a total number of documents participating in clustering, M represents a total number of accumulation points selected;
in the beginning, M documents serve as accumulation points of the clustering, residual N−M documents are added in the M clusters;
Cluster(pᵣ), r=1, 2, . . . , M represents a set of each cluster;
in the beginning, each set only has one document serving as the accumulation points;
for a document i not participating in the clusters, a most similar cluster is calculated according to a following expression:
$${p}_{q} = Arg {Max}_{r = 1 , 2 , … , M} \{ \frac{{\sum }_{p ∈ Cluster ( {p}_{r} )} Proximity ( p , i )}{\vert Cluster ( {p}_{r} ) \vert} \} ;$$
in the expression mentioned above, a similarity of between a document i not added in the clusters and all documents in the set Cluster(pᵣ) of each cluster, an average is taken for serving as a similarity of the document i and the clusters;
a maximum of all the clusters is taken for serving as a most similar cluster to the document i;
the residual N−M documents are added to the set of the clusters, each time a document i_{q} having a maximum similarity is added to the set of the clusters, and the Cluster(p_{q}) is updated, and finally all the documents are added to the set of the clusters.

28: The clustering method, as recited in claim 15, wherein in the step 5, N represents a total number of documents participating in clustering, M represents a total number of accumulation points selected;
in the beginning, M documents serve as accumulation points of the clustering, residual N−M documents are added in the M clusters;
Cluster(pᵣ), r=1, 2, . . . , M represents a set of each cluster;
in the beginning, each set only has one documents serving as the accumulation points;
for a document i not participating in the clusters, a most similar cluster is calculated according to a following expression:
$${p}_{q} = Arg {Max}_{r = 1 , 2 , … , M} \{ \frac{{\sum }_{p ∈ Cluster ( {p}_{r} )} Proximity ( p , i )}{\vert Cluster ( {p}_{r} ) \vert} \} ;$$
in the expression mentioned above, a similarity of between a document i not added in the clusters and all documents in the set Cluster(pᵣ) of each cluster, an average is taken for serving as a similarity of the document i and the clusters;
a maximum of all the clusters is taken for serving as a most similar cluster to the document i;
the residual N−M documents are added to the set of the clusters, each time a document i_{q} having a maximum similarity is added to the set of the clusters, and the Cluster(p_{q}) is updated, and finally all the documents are added to the set of the clusters.

29: The clustering method, as recited in claim 24, wherein in the step 5, N represents a total number of documents participating in clustering, M represents a total number of accumulation points selected;
in the beginning, M documents serve as accumulation points of the clustering, residual N−M documents are added in the M clusters;
Cluster(pᵣ), r=1, 2, . . . , M represents a set of each cluster;
in the beginning, each set only has one documents serving as the accumulation points;
for a document i not participating in the clusters, a most similar cluster is calculated according to following expression:
$${p}_{q} = Arg {Max}_{r = 1 , 2 , … , M} \{ \frac{{\sum }_{p ∈ Cluster ( {p}_{r} )} Proximity ( p , i )}{\vert Cluster ( {p}_{r} ) \vert} \} ;$$
in the expression mentioned above, a similarity of between a document i not added in the clusters and all documents in the set Cluster(pᵣ) of each cluster, an average is taken for serving as a similarity of the document i and the clusters;
a maximum of all the clusters is taken for serving as a most similar cluster to the document i;
the residual N−M documents are added to the set of the clusters, each time a document i_{q} having a maximum similarity is added to the set of the clusters, and the Cluster(p_{q}) is updated, and finally all the documents are added to the set of the clusters.

30: The clustering method as recited in claim 12, wherein the step 6 comprises a step of disposing M clusters in the circular ring structure, in such a manner that clusters having more similar characteristics are distributed closer, and clusters having more dissimilar characteristics are distributed farther;
wherein in an initial condition, two clusters are randomly selected to be added to the circular ring structure, and residual M−2 clusters are added to the circular ring structure in sequence according to a following formula:
$$( {p}_{s} , {p}_{t} ) = Arg Max \{ \begin{matrix}\frac{{\sum }_{i ∈ Cluster ( {p}_{r} ) , j ∈ Cluster ( {p}_{s} )} Proximity ( i , j )}{\vert Cluster ( {p}_{r} ) \vert \vert Cluster ( {p}_{s} ) \vert} + \\ \frac{{\sum }_{i ∈ Cluster ( {p}_{r} ) , k ∈ Cluster ( {p}_{t} )} Proximity ( i , k )}{\vert Cluster ( {p}_{r} ) \vert \vert Cluster ( {p}_{t} ) \vert}\end{matrix} \} ;$$
when each cluster pᵣ is added to the circular ring structure, a suitable position is sought according to the formula mentioned above and a new ring for disposing the cluster pᵣ is added between two most similar clusters pₛ and pₜ;
wherein in the circular ring structure, the closer is a cluster to the cluster pᵣ, the more similar is the cluster to the cluster pᵣ, and otherwise the farther is a cluster to the cluster pᵣ, the more dissimilar is the cluster to the cluster pᵣ.

31: The clustering method as recited in claim 29, wherein in the step 6, M clusters are disposed in the circular ring structure, in such a manner that clusters having more similar characteristics are distributed closer, and clusters having more dissimilar characteristics are distributed farther;
wherein in an initial condition, two clusters are randomly selected to be added to the circular ring structure, and residual M−2 clusters are added to the circular ring structure in sequence according to a following formula:
$$( {p}_{s} , {p}_{t} ) = Arg Max \{ \begin{matrix}\frac{{\sum }_{i ∈ Cluster ( {p}_{r} ) , j ∈ Cluster ( {p}_{s} )} Proximity ( i , j )}{\vert Cluster ( {p}_{r} ) \vert \vert Cluster ( {p}_{s} ) \vert} + \\ \frac{{\sum }_{i ∈ Cluster ( {p}_{r} ) , k ∈ Cluster ( {p}_{t} )} Proximity ( i , k )}{\vert Cluster ( {p}_{r} ) \vert \vert Cluster ( {p}_{t} ) \vert}\end{matrix} \} ;$$
when each cluster pᵣ is added to the circular ring structure, a suitable position is sought according to the formula mentioned above and a new ring for disposing the cluster pᵣ is added between two most similar clusters pₛ and pₜ;
wherein in the circular ring structure, the closer is a cluster to the cluster pᵣ, the more similar is the cluster to the cluster pᵣ, and otherwise the farther is a cluster to the cluster pᵣ, the more dissimilar is the cluster to the cluster pᵣ.
